(19) United States
(12) Patent Application Publication
(10) Pub. No.: US 2021/0336781 A1
(43) Pub. Date: Oct. 28, 2021

(54) NETWORK DEVICE, METHOD FOR SECURITY AND COMPUTER READABLE STORAGE MEDIUM

(71) Applicant: HEWLETT PACKARD ENTERPRISE DEVELOPMENT LP, Houston, TX (US)

(72) Inventors: Xuguang Jia, Beijing (CN); Qiang Zhou, Santa Clara, CA (US); Guangzhi Ran, Beijing (CN); Jianpo Han, Beijing (CN)

(21) Appl. No.: 17/259,627

(22) PCT Filed: Jun. 6, 2019
(86) PCT No.: PCT/US2019/035873

§ 371 Date: Jan. 12, 2021

(30) Foreign Application Priority Data
Jul. 18, 2018 (CN) 201810792898.9

(51) Int. Cl. H04L 9/08; H04L 9/30

(52) U.S. Cl. CPC H04L 9/0897; H04L 9/3073; H04L 9/083

(57) ABSTRACT

The present application discloses a network device, a method for security and a computer readable storage medium. The example network device may include a processor to perform: acquiring data to be processed from a downstream device, and transmitting it to a trusted platform module (TPM); and after the TPM encrypts the data to be processed using a cloud key stored therein, receiving the encrypted data for subsequent usage. The processor is further to perform: sending a request to a remote server to acquire the cloud key; and forwarding the acquired cloud key to the TPM for storage.

### BACKGROUND

Internet of Things (IoT) related technology has been broadly applied in various industries and people's daily lives. The intelligent devices, such as smart street lamp, smart camera, smart windows, etc., can greatly improve people's lives.

### BRIEF DESCRIPTION OF THE DRAWINGS

FIG. 1 is a block diagram illustrating an example IoT system according to present disclosure.

FIG. 2 is a diagram illustrating an example case of securing the downstream device according to present disclosure.

FIG. 3 is a diagram illustrating an example case of acquiring a cloud key according to present disclosure.

FIG. 4 a diagram illustrating another example case of securing the downstream device according to present disclosure.

FIG. 5 is a diagram illustrating an example case of acquiring a key pair comprising a private key and a public key according to present disclosure.

FIG. 6 is a diagram illustrating an example entire case of securing the downstream device according to present disclosure.

FIG. 7 is a flow chart illustrating an example method of securing the downstream device according to present disclosure.

FIG. 8 is a flow chart illustrating an example method of acquiring a cloud key according to present disclosure.

FIG. 9 is a flow chart illustrating another example method of securing the downstream device according to present disclosure.

FIG. 10 is a flow chart illustrating an example method of acquiring a key pair comprising a private key and a public key according to present disclosure.

FIG. 11 is a block diagram illustrating an example network device according to present disclosure.

FIG. 12 is a block diagram illustrating another example network device according to present disclosure.

FIG. 13 is a block diagram illustrating another example network device according to present disclosure.

### DETAILED DESCRIPTION

An internet of Things (IoT) system typically employs communication protocols such as WiFi, Bluetooth Low Energy (BLE), ZigBee, 6LoWPAN etc. Systems using these protocols typically include downstream device such as the endpoint device and the network device such as the master device. The network device may act as the first gateway between the downstream device and the external network.

For example, the WiFi wireless communication system includes the Station (STA) network device (commonly known as Access Point (AP)) and the STA downstream device. The STA network device provides an infrastructure Basic Service Set (BSS) in which the STA downstream device can join. Although, aspects of a Wifi system are discussed in this application, the techniques described herein can be used with a variety of communication protocols

In general, the IoT system needs a plurality of different IoT downstream devices, for example thousands of IoT downstream devices, to collect raw data from an environment and passes the collected data to a remote IoT server via the network device.

However, these downstream devices in the IoT system generally are not unmanned. And in the IoT system, most of IoT downstream devices may not be provided with a trusted platform module (TPM) in order to save a cost. Thus, these downstream devices may lack the capability to provide the trusted security services, such as self-generating key pairs, data encryption and decryption, software integrity check, data trust zone, and secret keys or certificate authority (CA) certs storage, etc.

In contrast, the IoT network device generally has a higher security requirement, and thus may be provided with the TPM. As a result, the network device can provide these trusted security service.

Accordingly, these IoT downstream devices can cause the whole IoT system to lack security and may cause the entire IoT system to be more vulnerable to malicious attacks, which makes people to pay attention to the security of the IoT downstream device.

In order to improve the security of the downstream device, the IoT downstream device without the TPM uses the TPM on the network device, so as to perform the data encryption/decryption and key pairs/cert management, etc. As a result, it can ensure the security of the IOT system while saving the cost of the IOT downstream devices.

In one example, a network device comprises a processor to perform the operations of: acquiring data to be processed from a downstream device, and transmitting it to a trusted platform module (TPM); and after the TPM encrypts the data to be processed using a cloud key stored therein, receiving the encrypted data for subsequent usage. Further, the processor sends a request to a remote server to acquire the cloud key, and forwards the acquired cloud key to the TPM for storage.

In another example, a method comprises acquiring, by a processor of a network device, data to be processed from a downstream device, and transmitting it to a trusted platform module (TPM); and after the TPM encrypts the data to be processed using a cloud key stored therein, receiving, by the processor, the encrypted data for subsequent usage.

In still another example, a non-transitory computer readable storage medium stores instructions that, when executed by a processor of a network device, causes the processor to perform the operations of: acquiring data to be processed from a downstream device, and transmitting it to a trusted platform module (TPM); and after the TPM encrypts the data to be processed using a cloud key stored therein, receiving the encrypted data for subsequent usage.

As used herein, a “network device” generally includes a device that is adapted to transmit and/or receive signaling and to process information within such signaling and to provide wireless local area network services to a station (e.g., any data processing equipment such as a computer, cellular phone, personal digital assistant, tablet devices, etc.). The “network device” may include access points, data transfer devices, network switches, routers, controllers, etc. As used herein, an “access point” (AP) generally refers to receiving points for any known or convenient wireless access technology which may later become known. Specifically, the term AP is not intended to be limited to IEEE 802.11-based APs. APs generally function as an electronic device that is adapted to allow wireless devices to connect to a wired network via various communications standards.

As used herein, a “Trusted Platform Module (TPM)” is an international standard for a secure cryptoprocessor, a dedicated microcontroller designed to secure hardware through integrated cryptographic keys. TPM was proposed by a computer industry consortium called Trusted Computing Group (TCG). The last revised TPM Main Specification is Version 1.2, and the current latest TPM Specification is Version 2.0. The TPM typically includes a microprocessor, a Flash, a random number generator, a RSA engine, a Secure Hash Algorithm (SHA) co-processor, etc. The RSA engine typically may be used to achieve asymmetric cryptography and signature authentication. The SHA co-processor may be used to achieve the integrity measurement. Symmetric cryptography can use any algorithm.

It is appreciated that examples described herein below may include various components and features. Some of the components and features may be removed and/or modified without departing from a scope of the device, method and non-transitory computer readable storage medium for. It is also appreciated that, in the following description, numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example. As used herein, a component is a combination of hardware and software executing on that hardware to provide a given functionality.

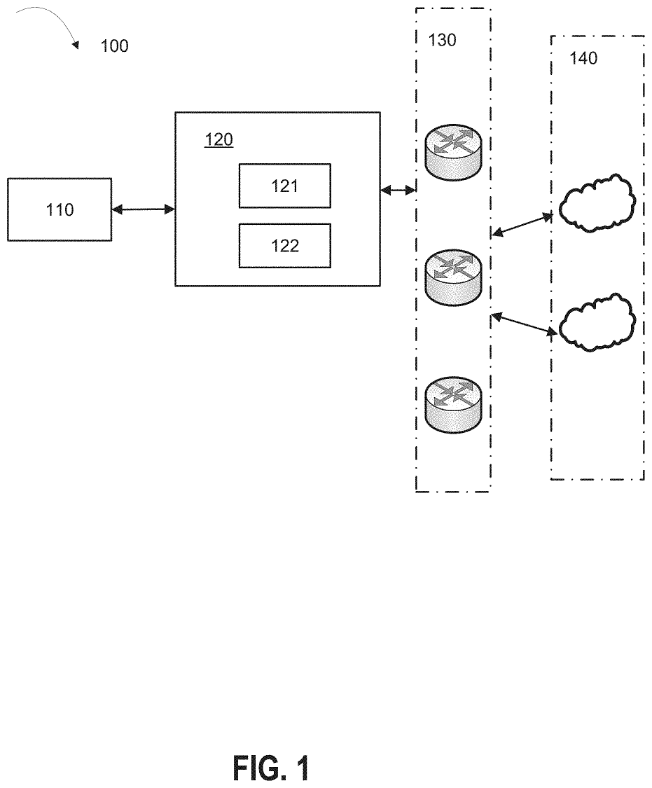

FIG. 1 is a block diagram illustrating an example IoT system according to present disclosure.

Referring to FIG. 1, an IoT system 100 may include a downstream device 110, such as an endpoint device, a network device 120, such as an access point (AP), a remote server 130 and a network 140.

The downstream device 110 may be a physical device, a vehicle, a home appliance, or other devices embedded with electronics, software, sensors, actuators etc. The downstream device 110 may collect various kinds of data from the environment.

In consideration of cost, the downstream device 110 may not be provided with a trusted platform module (TPM). Thus, the downstream device 110 may lack the capability for data encryption and decryption and secret keys or certificate authority (CA) certs storage, etc.

The network device 120 may act as the first gateway between the downstream device 110 and the network 140, and may be used as an AP to access the downstream device 110 to the network 140 via the remote server 130.

The network device 120 may include a processor 121. Further, in consideration of a higher security requirement, the network device 120 may include a TPM 122. Thus, the network device 120 with the TPM 122 may have abilities of data encryption and decryption and secret keys or CA certs storage, etc.

The downstream device 110 may use the TPM 122 of the network device 120, so as to perform the data encryption/decryption and key pairs/cert management, etc. As a result, it can ensure the security of the downstream device 110 while saving the cost of the downstream device 110.

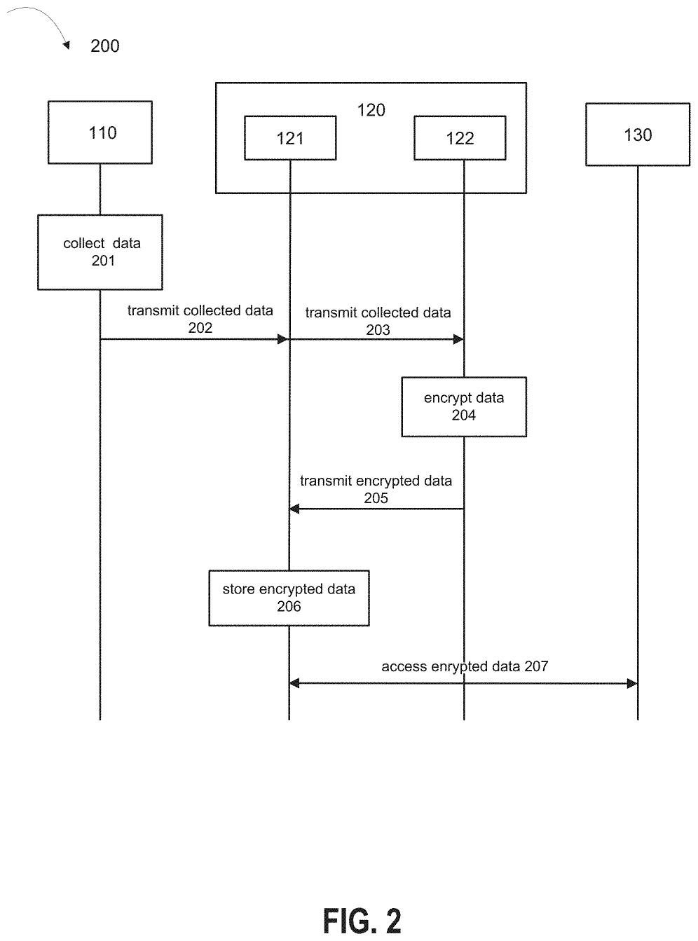

FIG. 2 is a diagram illustrating an example case of securing the downstream device according to present disclosure.

Referring to FIG. 2, the example case 200 may include the following processes.

The downstream device 110 may collect raw data from the environment, at 201. The downstream device 110 may encrypt the raw data using symmetric cryptography and transmit the encrypted data to the network device 120.

Alternatively, in an example, the downstream device 110 may transmit the raw data directly to the network device 120 without encryption. Depending on the configuration of the downstream device 110 and the specific requirement for the collected data, the collected data may be encrypted or not be encrypted.

Then, the downstream device 110 may transmit the collected data to the processor 121 of the network device 120, at 202. The processor 121 may transmit the collected data to the TPM 122 of the network device 120, at 203.

The TPM 122 may encrypt the collected data using a cloud key stored therein, at 204, and may transmit the encrypted data to the processor 121 of the network device 120, at 205.

The processor 121 of the network device 120 may locally store the encrypted data, at 206, for access by the remote server 130, at 207.

Alternatively, in an example, the processor 121 of the network device 120 may transmit the encrypted data to the remote server 130.

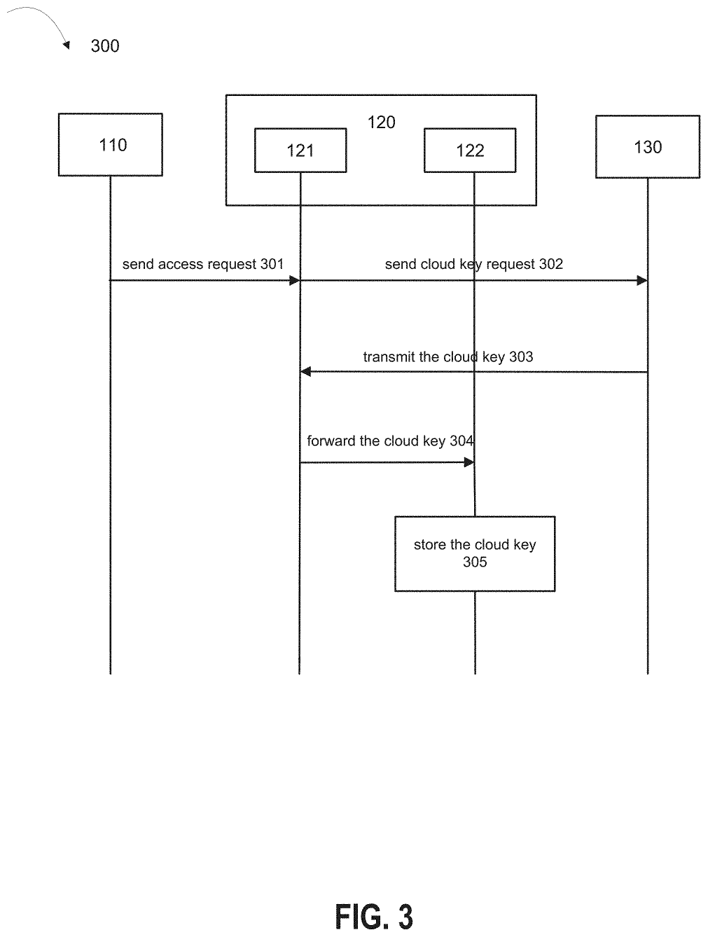

Subsequently, the detailed description regarding how to acquire the cloud key will be provided with reference to FIG. 3.

FIG. 3 is a diagram illustrating an example case of acquiring a cloud key according to present disclosure.

Referring to FIG. 3, the example case 300 may include the following processes.

The downstream device 110 may send an access request to the network device 120, at 301.

Upon receipt of the access request from the downstream device 110, the processor 121 of the network device 120 may send a request to the remote server 130 to acquire a cloud key, at 302.

Upon receipt of the request for cloud key from the processor 121 of the network device 120, the remote server 130 may transmit the cloud key to the processor 121 of the network device 120, at 303.

The cloud key may be generated by the remote server 130 itself and stored locally.

Alternatively, in an example, the cloud key may be generated by a specific server in the network 140 (shown in FIG. 1). The remote server 130 may send a request to the specific server to acquire the cloud key, upon receipt of the request for the cloud key from the processor 121 of the network device 120.

Then, the processor 121 may forward the cloud key to the TPM 122 of the network device 120, at 304. The TPM 122 may store the cloud key in its own storage device, at 305.

In combination with FIG. 2 and FIG. 3, after acquiring the cloud key, the TPM 122 may encrypt the collected data using the cloud key stored therein, and may send the encrypted data to the processor 121 of the network device 122 for subsequent usage.

As described above, the downstream device 110 may use the TPM 122 of the network device 120 to encrypt the collected data. As a result, the security of data collected by the downstream device 110 may be guaranteed. Meanwhile, since the downstream device 110 may unnecessarily be provided with the TPM, the whole cost may be reduced.

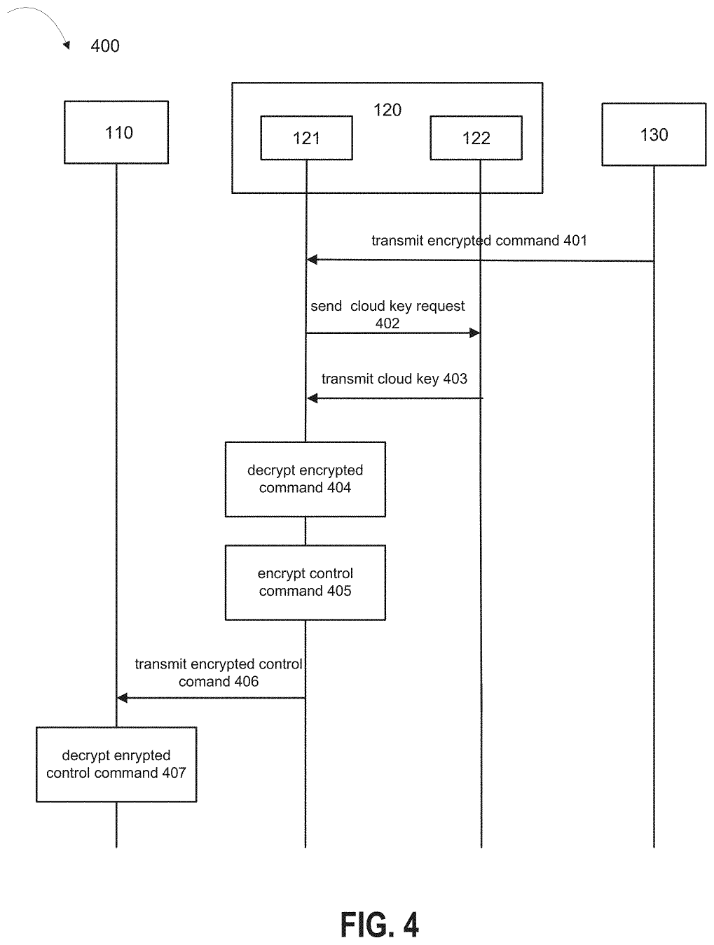

FIG. 4 a diagram illustrating another example case of securing the downstream device according to present disclosure.

Referring to FIG. 4, the example case 400 may include the following processes.

The remote server 130 may transmit an encrypted command to the processor 121 of the network device 120, at 401.

The processor 121 may send a request to the TPM 122 of the network device 120 to acquire the cloud key, at 402. The cloud key has been acquired and stored in the TPM 122 according to the example case 300 of FIG. 3.

The TPM 122 may transmit the cloud key to the processor 121, at 403, and the processor 121 may decrypt the encrypted command using the cloud key to acquire a control command, at 404.

Then, the processor 121 of the network device 120 may encrypt the control command using a private key, at 405, and may transmit the encrypted control command to the downstream device 110, at 406.

The downstream device 110 may decrypt the encrypted control command using a public key to acquire the control command, at 407. The private key and the public key may compose a key pair.

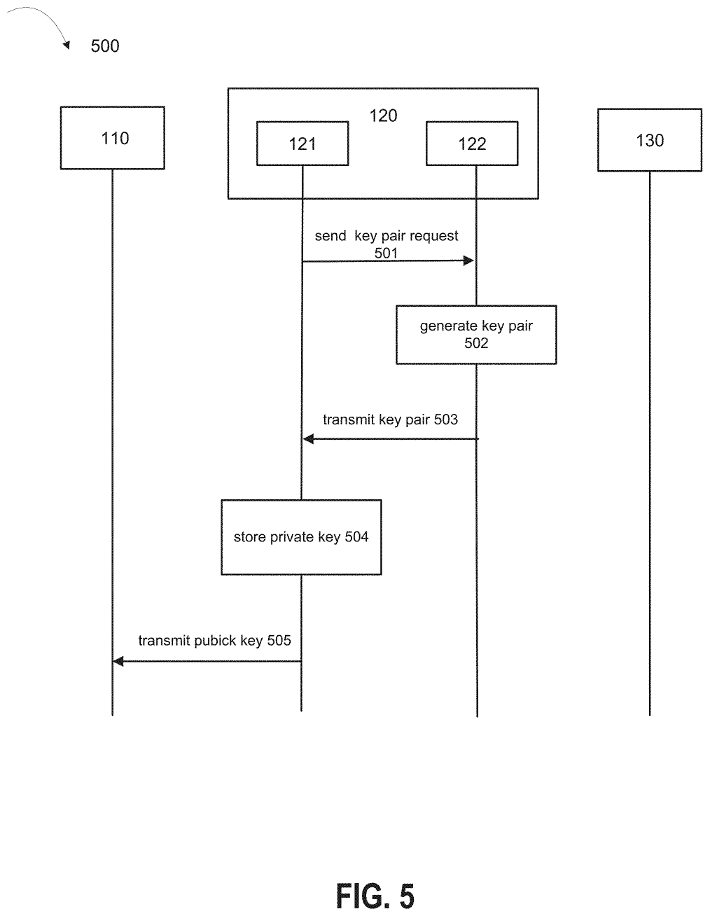

Subsequently, the detailed description regarding how to acquire the key pair comprising the private key and the public key will be provided with reference to FIG. 5.

FIG. 5 is a diagram illustrating an example case of acquiring a key pair comprising a private key and a public key according to present disclosure.

Referring to FIG. 5, the example case 500 may include the following processes.

The processor 121 of the network device 120 may send a request to the TPM 122 to acquire a key pair, at 501.

Upon receipt of the request from the processor 121, the TPM 122 may generate a key pair comprising a private key and a public key, at 502. Then, the TPM 122 may transmit the key pair to the processor 121 of the network device 120, at 503.

The processor 121 may store the private key locally, at 504, and may transmit the public key to the downstream device 110, at 505.

In combination with FIG. 4 and FIG. 5, the downstream device 110 may use the public key to decrypt the encrypted control command which is transmitted to the downstream device 110 from the network device 120, so as to acquire the control command.

As described above, the encrypted command from the remote server 130 may be decrypted by the processor 121 of the network device 120 using the cloud key provided by the remote server 130. Then, the acquired control command may be encrypted by the processor 121 of the network device 120 by using the private key generated by the TPM 122. Then, the downstream device 110 may decrypt the encrypted control command by using the public key generated by the TPM 122 to acquire the control command.

As a result, the security of control command from the remote server 130 may be guaranteed, and the cost of the downstream device 110 may be reduced.

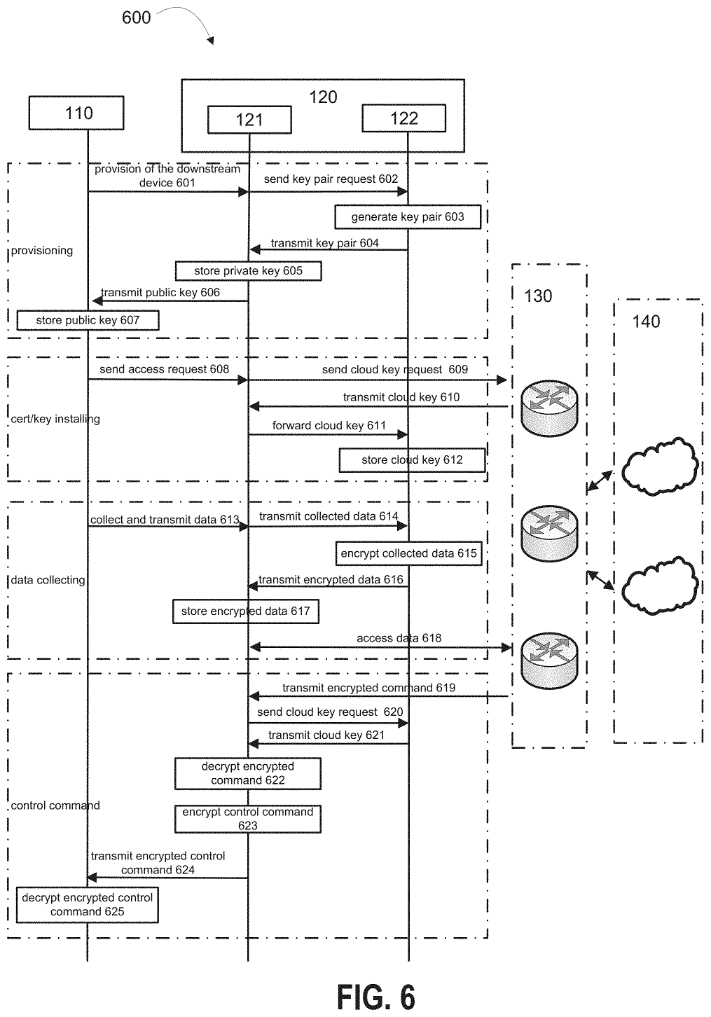

FIG. 6 is a diagram illustrating an example entire case of securing the downstream device according to present disclosure.

Firstly, the TPM 122 may verify the image integrity of the network device 120 before the network device 120 starts up.

Specifically, in order to guarantee a secure startup of the network device 120, it may need to verify the integrity of the bootloader image and OS image of the network device 120 by means of the TPM 122. If the TPM 122 verifies that the bootloader image and OS image are correct, the network device 120 may start up.

Secondly, the downstream device 110 may verify whether the network device 120 and the TPM 122 can be trusted.

The TPM 122 may have its own unique Endorsement Key (EK), which may be used to prove the identity of the TPM 122. This EK key typically may be referred to as a TPM private key, which may be generated in manufacturing of the TPM 122 and cannot export from the TPM 122. In addition, the TPM 122 may generate a TPM public key and then store it therein.

The network device 120 also may have its own vendor key, which may be used to prove the network device's identity. This vendor key typically may be referred to as a vendor private key, which may be generated in manufacturing of the network device 120 and cannot export from the TPM 122. In addition, the TPM 122 may generate a vendor public key and then store it in the TPM 122.

In general, two certs may be deployed in manufactory and stored in the TPM 122. One cert may be an EK cert, and another cert may be a vendor cert.

The EK cert may be not a self-signed cert made by the TPM vendor or the network device vendor, and may be published by the Windows Trusted Root Certification Authority (CA) approved by Microsoft from the Windows trust root.

In order to acquire the EK cert, in the process of manufacturing the TPM 122, the manufacture of the TPM 122 may send a Certificate Signing Request (CSR) including the TPM public key to the EK cert sign system with trusted CA, and then the EK cert sign system may send the EK cert approved by the Windows Trusted Root CA to the manufacture of the TPM 122. The EK cert may include the manufacture name of the TPM 122, the model of the TPM 122, the version number of the TPM 122, the TPM public key, etc.

In order to acquire the vendor cert, in the process of manufacturing the network device 120, the manufacture of the network device 120 may send a CSR including the vendor public key to the vendor cert self-sign system, and then the self-sign system may send the vendor cert to the manufacture of the network device 120. The vendor cert may include the manufacture name of the network device 120, the model of the network device 120, the version number of the network device 120, the vendor public key, etc.

In order to verify the TPM 122, the downstream device 110 may send a request to the TPM 122 to acquire the EK cert, and then verify the EK cert to identify the TPM 122.

In order to verify the network device 120, the downstream device 110 may send a request to the TPM 122 to acquire the vendor cert, and then verify the vendor cert to identify the network device 120.

Thirdly, it may need to provision the downstream device 110 on the network device 120.

There may be two example methods to provision the downstream device 110.

As a first example method, the network device 120 may maintain a white list for the downstream devices 110, and may use mac address to identify the downstream devices 110.

As a second example method, the network device 120 may act as a Certificate Authority (CA). The downstream device 110 may push its Certificate Signing Request (CSR) to the network device 120, and the network device 120 may maintain which of the downstream device 110 can get cert. The downstream device 110 which get cert can establish a trusted connection to the network device 120.

Fourthly, the downstream device 110 may work with the network device 120. Specifically, it may include four phases comprising a provisioning phase, a cert/key installing phase, a data collecting phase and a control command phase.

In the provisioning phase, the downstream device 110 may provision on the network device 120 using the above first example method, at 601. Then, the processor 121 of the network device 120 may send a request to the TPM 122 of the network device 120 to acquire a key pair, at 602.

The TPM 122 may generate a key pair including a public key and a private key, at 603, and may transmit the key pair to the processor 121 of the network device 110, at 604.

The processor 121 of the network device 120 may store the private key, at 605, and may transmit the public key to the downstream device 110, at 606. The downstream device 110 may store the public key locally, at 607.

In the cert/key installing phase, the downstream device 110 may send an access request to the processor 121 of the network device 120, at 608. Upon receipt of the access request, the processor 121 may send a request to a remote server 130 to acquire a cloud key, at 609.

The remote server 130 may transmit the cloud key to the processor 121 of the network device 120, at 610, and then the processor 121 may forward the cloud key to the TPM 122, at 611. The TPM 122 may store the cloud key, at 612.

In the data collecting phase, the downstream device 110 may collect the raw data from the environment and may transmit the collected data to the processor 121 of the network device 120, at 613.

The processor 121 may transmit the collected data to the TPM 122, at 614. The TPM 122 may encrypt the collected data using the cloud key stored therein, at 615, and may transmit the encrypted data to the processor 121, at 616.

The cloud key has been stored in the TPM 122 in the cert/key installing phase.

The processor 121 may store the encrypted data locally, at 617, for access by the remote server 130, at 618.

Alternatively, in an example, the processor 121 may transmit the encrypted data to the remote server 130.

In the control command phase, the remote server 130 may transmit an encrypted command to the processor 121 of the network device 120, at 619.

Then, the processor 121 may send a request to the TPM 122 of the network device 120 to acquire the cloud key, at 620. The cloud key has been acquired and stored in the TPM 122 in the cert/key installing phase.

The TPM 122 may transmit the cloud key to the processor 121, at 621, and the processor 121 may decrypt the encrypted command using the cloud key to acquire a control command, at 622.

Further, the processor 121 of the network device 120 may encrypt the control command using the private key acquired in the provisioning phase, at 623, and may transmit the encrypted control command to the downstream device 110, at 624.

The downstream device 110 may decrypt the encrypted control command using the public key acquired in the provisioning phase to acquire the control command, at 625. The private key and the public key may compose a key pair.

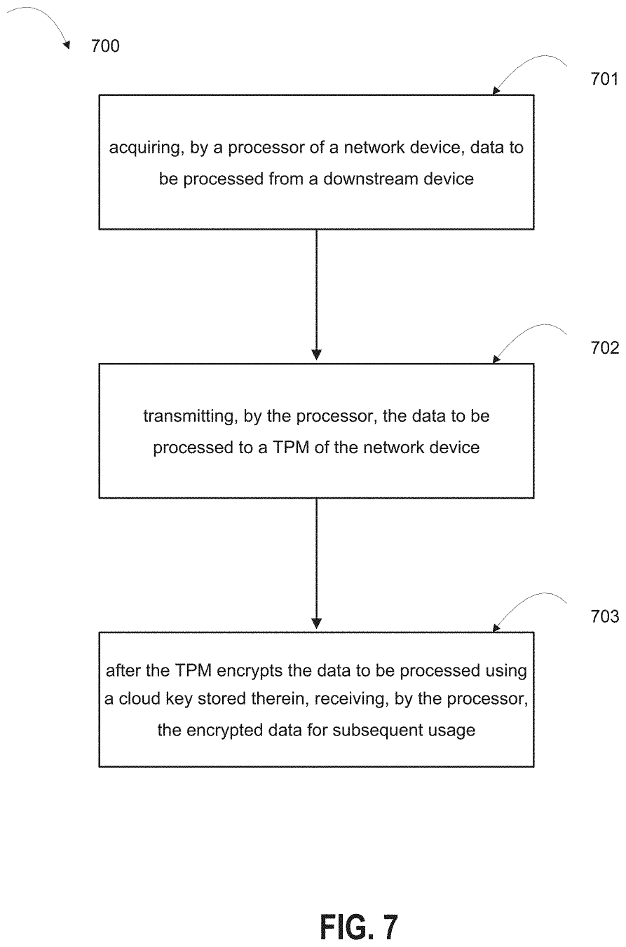

FIG. 7 is a flow chart illustrating an example method of securing the downstream device according to present disclosure.

Referring to FIG. 7, the method 700 may include: acquiring, by a processor of a network device, data to be processed from a downstream device, at 701; and transmitting, by the processor, the data to be processed to a trusted platform module (TPM) of the network device, at 702.

The method 700 may further include after the TPM encrypts the data to be processed using a cloud key stored therein, receiving, by the processor, the encrypted data for subsequent usage, at 703.

The subsequent usage may comprise storing the encrypted data in the network device for access by a remote server or transmitting the encrypted data to a remote server.

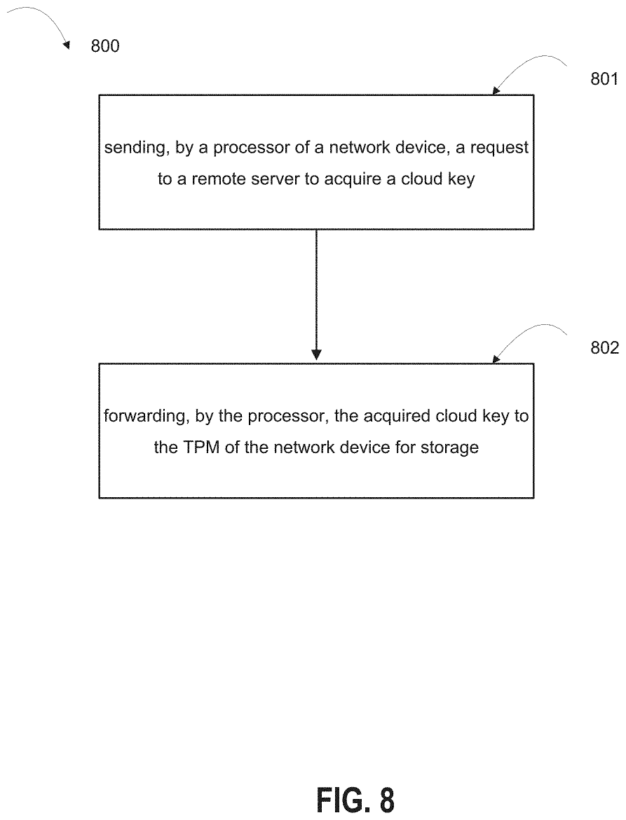

Subsequently, the detailed process regarding how to acquire the cloud key will be provided with reference to FIG. 8.

FIG. 8 is a flow chart illustrating an example method of acquiring a cloud key according to present disclosure.

Referring to FIG. 8, the method 800 may include: sending, by a processor of a network device, a request to a remote server to acquire a cloud key, at 801; and forwarding, by the processor, the acquired cloud key to the TPM of the network device for storage, at 802.

The cloud key may be generated by the remote server itself and may be stored locally.

Alternatively, in an example, the cloud key may be generated by a specific server in the network, and the remote server may send a request to the specific server to acquire the cloud key, upon receipt of the cloud key from the processor of the network device.

In combination with FIG. 7 and FIG. 8, after acquiring the cloud key, the TPM may encrypt the data to be processed using the cloud key stored therein, and may send the encrypted data to the processor of the network device for subsequent usage.

As described above, the downstream device may use the TPM of the network device to encrypt the data to be processed collected by the downstream device. As a result, the security of the collected data may be guaranteed. Meanwhile, since the downstream device may unnecessarily be provided with the TPM, the whole cost may be reduced.

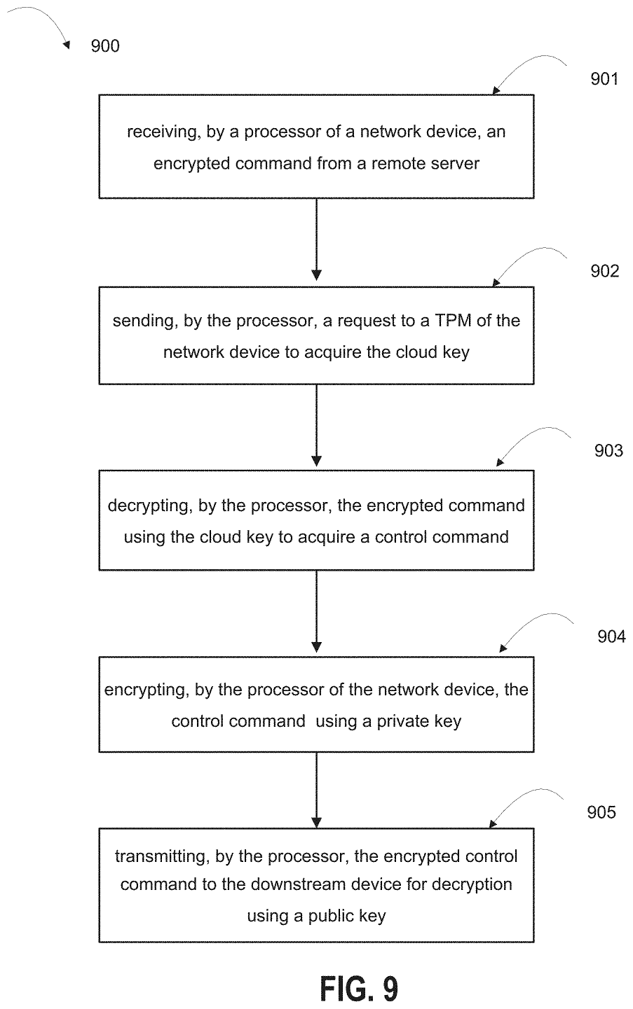

FIG. 9 is a flow chart illustrating another example method of securing the downstream device according to present disclosure.

Referring to FIG. 9, the method 900 may include: receiving, by a processor of a network device, an encrypted command from a remote server, at 901; and sending, by the processor, a request to a TPM of the network device to acquire the cloud key, at 902, wherein the cloud key has been acquired and stored in the TPM of the network device according to the method 800 of FIG. 8.

The method 900 also may include decrypting, by the processor, the encrypted command using the cloud key to acquire a control command, at 903.

The method 900 may further include: encrypting, by the processor of the network device, the control command acquired at 903 using a private key, at 904; and transmitting, by the processor, the encrypted control command to the downstream device for decryption using a public key, at 905.

The private key and the public key may compose a key pair.

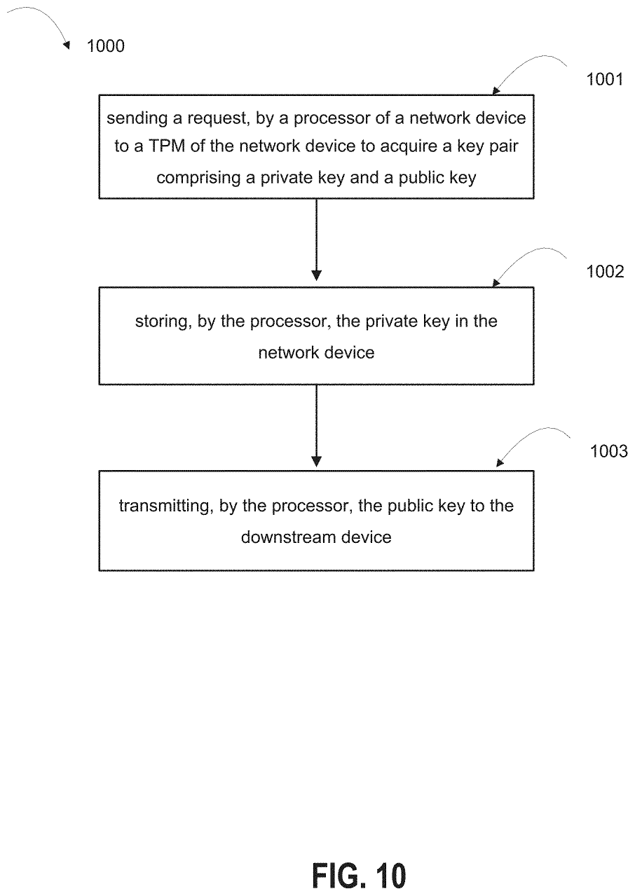

Subsequently, the detailed description regarding how to acquire the key pair comprising the private key and the public key will be provided with reference to FIG. 10.

FIG. 10 is a flow chart illustrating an example method of acquiring a key pair comprising a private key and a public key according to present disclosure.

Referring to FIG. 10, the method 1000 may include: sending a request, by a processor of a network device to a TPM of the network device to acquire a key pair comprising a private key and a public key, at 1001; storing, by the processor, the private key in the network device, at 1002; and transmitting, by the processor, the public key to the downstream device, at 1003.

In combination with FIG. 9 and FIG. 10, the downstream device may use the public key to decrypt the encrypted control command which is transmitted to the downstream device from the network device, so as to acquire the control command.

As described above, the encrypted command from the remote server may be decrypted by the processor of the network device using the cloud key provided by the remote server. Then, the acquired control command may be encrypted by the processor of the network device by using the private key generated by the TPM. Lastly, the downstream device may decrypt the encrypted control command by using the public key generated by the TPM to acquire the control command.

As a result, the security of control command from the remote server 130 may be guaranteed, and the cost of the downstream device 110 may be reduced.

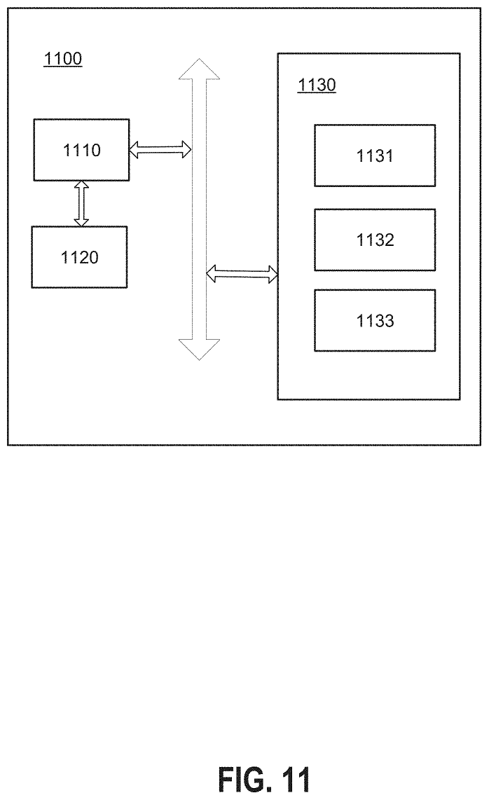

FIG. 11 is a block diagram illustrating an example network device according to present disclosure.

Referring to FIG. 11, the network device 1100 may include a processor 1110, a TPM 1120 and a non-transitory computer readable storage medium 1130.

The non-transitory computer readable storage medium 1130 may store instructions executable by the possessor 1110.

The instructions may include data acquiring instruction 1131 that, when executed by the processor 1110, may cause the processor 1110 to acquire data to be processed from a downstream device.

The instructions may also include data transmitting instruction 1132 that, when executed by the processor 1110, may cause the processor 1110 to transmit the data to be processed to the TPM 1120 of the network device 1100.

The instructions may also include data receiving instruction 1133 that, when executed by the processor 1110, may cause the processor 1110 to receive the encrypted data for subsequent usage, after the TPM encrypts the data to be processed using a cloud key stored therein.

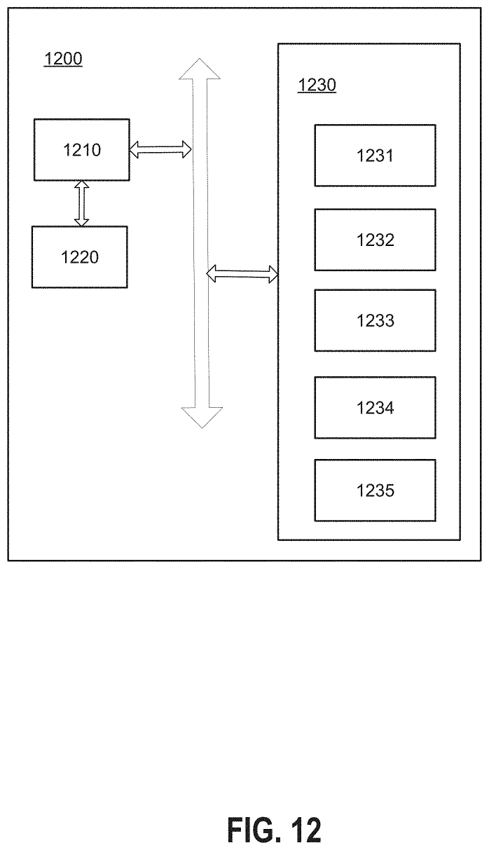

FIG. 12 is a block diagram illustrating another example network device according to present disclosure.

Referring to FIG. 12, the network device 1200 may include a processor 1210, a TPM 1220 and a non-transitory computer readable storage medium 1230.

The non-transitory computer readable storage medium 1230 may store instructions executable by the possessor 1210.

The instructions may include data acquiring instruction 1231 that, when executed by the processor 1210, may cause the processor 1210 to acquire data to be processed from a downstream device.

The instructions may also include data transmitting instruction 1232 that, when executed by the processor 1210, may cause the processor 1210 to transmit the data to be processed to the TPM 1220 of the network device 1200.

The instructions may also include request sending instruction 1233 that, when executed by the processor 1210, may cause the processor 1210 to send a request to a remote server to acquire a cloud key.

The instructions may also include key forwarding instruction 1234 that, when executed by the processor 1210, may cause the processor 1210 to forward the acquired cloud key to the TPM 1220 for storage.

The instructions may also include data receiving instruction 1235 that, when executed by the processor 1210, may cause the processor 1210 to receive the encrypted data for subsequent usage, after the TPM 1220 encrypts the data to be processed using the cloud key stored therein.

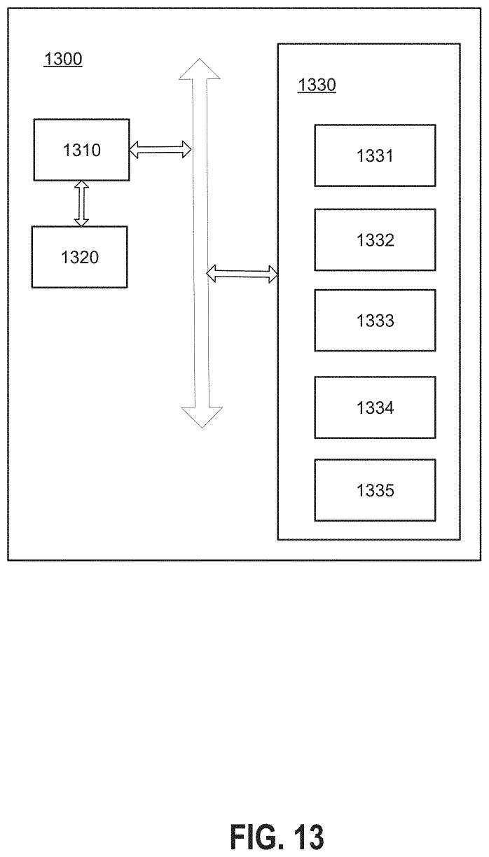

FIG. 13 is a block diagram illustrating another example network device according to present disclosure.

Referring to FIG. 13, the network device 1300 may include a processor 1310, a TPM 1320 and a non-transitory computer readable storage medium 1330.

The non-transitory computer readable storage medium 1330 may store instructions executable by the possessor 1310.

The instructions may also include command receiving instruction 1331 that, when executed by the processor 1310, may cause the processor 1310 to receive an encrypted command from a remote server.

The instructions may also include request sending instructions 1332 that, when executed by the processor 1310, may cause the processor 1310 to send a request to the TPM 1320 to acquire a cloud key.

The instructions may also include command decrypting instruction 1333 that, when executed by the processor 1310, may cause the processor 1310 to decrypt the encrypted command using the cloud key to acquire a control command.

The instructions may also include command encrypting instruction 1334 that, when executed by the processor 1310, may cause the processor 1310 to encrypt the control command using a private key.

The instructions may also include command transmitting instruction 1335 that, when executed by the processor 1310, may cause the processor 1310 to transmit the encrypted control command to the downstream device for decryption using a public key.

The private key and the public key may compose a key pair.

In addition, in an example, the processor 1310 may send a request to the TPM 1320 to acquire the key pair; store the private key in the network device 1300; and transmit the public key to the downstream device.

FIGS. 1 to 13 are illustrative and expressions or steps are simplified considering space of pages, their corresponding detail and complete explanations and definitions are recorded in the DETAILED DESCRIPTION. Even the manner of presentation might be different between them, the technical meanings could be understood to be similar in essence.

While the present disclosure has been described in connection with certain example embodiments, it is to be understood that the disclosure is not limited to the disclosed embodiments, but, on the contrary, is intended to cover various modifications and equivalent arrangements included within the spirit and scope of the appended claims, and equivalents thereof.

What is claimed is:

1. A network device comprising a processor to perform:
acquiring data to be processed from a downstream device, and transmitting it to a trusted platform module (TPM); and
after the TPM encrypts the data to be processed using a cloud key stored therein, receiving the encrypted data for subsequent usage.

2. The network device of claim 1, wherein the processor is further to perform:
sending a request to a remote server to acquire the cloud key; and
forwarding the acquired cloud key to the TPM for storage.

3. The network device of claim 1, wherein the subsequent usage comprises storing the encrypted data in the network device.

4. The network device of claim 1, wherein the subsequent usage comprises transmitting the encrypted data to a remote server.

5. The network device of claim 1, wherein the processor is further to perform:
receiving an encrypted command from a remote server;
sending a request to the TPM to acquire the cloud key; and
decrypting the encrypted command using the cloud key to acquire a control command.

6. The network device of claim 5, wherein the processor is further to perform:
encrypting the control command using a private key; and
transmitting the encrypted control command to the downstream device for decryption using a public key,
wherein the private key and the public key composes a key pair.

7. The network device of claim 6, wherein the processor is further to perform:
sending a request to the TPM to acquire the key pair;
storing the private key in the network device; and
transmitting the public key to the downstream device.

8. A method comprising:
acquiring, by a processor of a network device, data to be processed from a downstream device, and transmitting it to a trusted platform module (TPM); and
after the TPM encrypts the data to be processed using a cloud key stored therein, receiving, by the processor, the encrypted data for subsequent usage.

9. The method of claim 8, further comprising:
sending a request to a remote server to acquire the cloud key; and
forwarding the acquired cloud key to the TPM for storage.

10. The method of claim 8, wherein the subsequent usage comprises storing the encrypted data in the network device.

11. The method of claim 8, wherein the subsequent usage comprises transmitting the encrypted data to a remote server.

12. The method of claim 8, further comprising:
receiving an encrypted command from a remote server;
sending a request to the TPM to acquire the cloud key; and
decrypting the encrypted command using the cloud key to acquire a control command.

13. The method of claim 12, further comprising:
encrypting the control command using a private key; and
transmitting the encrypted control command to the downstream device for decryption using a public key,
wherein the private key and the public key composes a key pair.

14. The method of claim 13, further comprising:
sending a request to the TPM to acquire the key pair;
storing the private key in the network device; and
transmitting the public key to the downstream device.
